(19) United States
(12) Patent Application Publication
(10) Pub. No.: US 2013/0322334 A1
(43) Pub. Date: Dec. 5, 2013

(54) HARQ Buffer Size Reduction in Wireless Systems for Downlink Shared Channels

(71) Applicant: Nabil Yousef Wasily, Foothill Ranch, CA (US)

(72) Inventor: Nabil Yousef Wasily, Foothill Ranch, CA (US)

(73) Assignee: NEWPORT MEDIA, INC., Lake Forest, CA (US)

(21) Appl. No.: 13/904,023

(22) Filed: May 29, 2013

Related U.S. Application Data
(60) Provisional application No. 61/652,699, filed on May 29, 2012.

(51) Int. Cl. H04W 72/12

(52) U.S. Cl. CPC H04W 72/1284
USPC 370/328

(57) ABSTRACT

A receiver arranged to process a flow of data in a communication system for downlink shared channels and a method for processing the flow of data sequence. The receiver includes a processor that receives a subframe comprising a data packet; a demapper that receives supplemental channel data symbols and is positioned after the processor in a sequence of the flow of data; means for performing rate matching of estimated the data symbols and positioned after the demapper in the data sequence; and a Hybrid Automatic Retransmission Request (HARQ) buffer positioned before the demapper in the data sequence. The communication system includes a long-term evolution (LTE) communication system.

### CROSS-REFERENCE TO RELATED APPLICATIONS

This application claims priority to U.S. Provisional Application Ser. No. 61/652,699 filed on May 29, 2012, the complete disclosure of which, in its entirety, is herein incorporated by reference.

### BACKGROUND

1. Technical Field

The embodiments herein generally relate to wireless technologies, and, more particularly, to long-term evolution (LTE) technologies.

2. Description of the Related Art

The LTE system classifies the user equipment (UE) into five categories according to the Hybrid Automatic Retransmission Request (HARQ) buffer size, and based on this category the evolved Node B (eNodeB) sets the peak data rate for transmission. Each UE must be capable of processing up to eight parallel HARQ processes, whereby each process handles one or two (if spatial multiplexing is used) transport blocks. One transport block (or two in case of spatial multiplexing) will take 1 ms (one subframe) for transmission, and the processing time must be less than 3 ms as shown in FIG. 1, which shows HARQ parallel processes and processing time constraints.

TABLE 1
UE Categories

| | Maximum number | Maximum number | Total | Maximum number |
|---|---|---|---|---|
| | of DL-SCH | of bits of a | number | of supported |
| | transport block | DL-SCH transport | of soft | layers for spatial |
| UE | bits received | block received | channel | multiplexing in |
| Category | within a TTI | within a TTI | bits | DL |
| Category 1 | 10296 | 10296 | 250368 | 1 |
| Category 2 | 51024 | 51024 | 1237248 | 2 |
| Category 3 | 102048 | 75376 | 1237248 | 2 |
| Category 4 | 150752 | 75376 | 1827072 | 2 |
| Category 5 | 299552 | 149776 | 3667200 | 4 |

Table 1 summarizes the features of each UE category where the second column is the maximum data bits to be transmitted in one subframe (1 ms), the third column is the maximum number of bits transmitted within a transport block, and the fourth column is the regular HARQ buffer size.

However, the problem with this system is as follows: Each transport block is stored as soft bits in the HARQ buffer, but if it fails in the cyclic redundancy check (CRC), the receiver will ask for retransmission through a non-acknowledgement (NACK) signal, and part of the retransmitted block will overlap with the previous block and some of it will be new which increases the code rate. The overlapped part is selectively combined. Therefore, assuming the bit width for the soft bit is eight bits and the UE category is #4, the required HARQ buffer memory, which is the total number of soft channel bits (Nsoft)=1827072 (see Table 1). Now, the total required memory at the receiver side in the UE is: Nsoft*8(bit width)=14.616576 MB. This memory is huge and will dominate the chip area. Accordingly, it is desirable to develop a solution to reduce the memory domination in the chip area.

### SUMMARY

In view of the foregoing, an embodiment herein provides a receiver arranged to process a flow of data in a communication system for downlink shared channels, the receiver comprising a processor that receives a subframe comprising a data packet; a demapper that receives supplemental channel data symbols and is positioned after the processor in a sequence of the flow of data; means for performing rate matching of estimated the data symbols and positioned after the demapper in the data sequence; and a Hybrid Automatic Retransmission Request (HARQ) buffer positioned before the demapper in the data sequence. The supplemental channel data symbols may be arranged in a transport block that is stored as Quadrature amplitude modulation (QAM) symbols in the HARQ buffer. The data packet may be retransmitted in the data sequence, wherein the data packet may be entirely stored in the HARQ buffer.

The receiver may further comprise a combiner positioned after the means for performing rate matching in the data sequence; and a turbo decoder positioned after the combiner in the data sequence. The stored QAM symbols may be re-demapped, combined on a log-likelihood ratio (LLR) level with all previous retransmissions of the data packet, and applied to the turbo decoder. The processor may transmit channel state information (CSI) to the HARQ buffer. The QAM symbols may comprise in-phase and quadrature components. The HARQ buffer may store only reference signals. The reference signals may be transmitted during transmission of orthogonal frequency-division multiplexing (OFDM) symbols, wherein the reference signals may be transmitted during transmission of a first and fifth OFDM symbol of each slot when a short cyclic prefix (CP) is used, wherein the reference signals may be transmitted during transmission of a first and fourth OFDM symbol of each slot when a long cyclic prefix (CP) is used, and wherein the reference signals are transmitted every sixth subcarrier. The communication system may comprise a LTE communication system.

Another embodiment provides a method for processing a flow of data in a receiver in a communication system for downlink shared channels, the method comprising receiving a subframe comprising a data packet in a processor; positioning a demapper that receives supplemental channel data symbols after the processor in a sequence of the flow of data; performing rate matching of estimated the data symbols after demapping of the data symbols; and positioning a HARQ buffer before the demapper in the data sequence. The supplemental channel data symbols may be arranged in a transport block that is stored as QAM symbols in the HARQ buffer. The data packet may be retransmitted in the data sequence, wherein the data packet may be entirely stored in the HARQ buffer.

The method may further comprise combining code blocks after the rate matching is performed; and decoding the code blocks after the combining occurs. The stored QAM symbols may be re-demapped, combined on a LLR level with all previous retransmissions of the data packet, and applied to a turbo decoder that performs the decoding. The method may further comprise transmitting CSI to the HARQ buffer. The QAM symbols may comprise in-phase and quadrature components. The method may further comprise storing only reference signals in the HARQ buffer. The reference signals may be transmitted during transmission of OFDM symbols, wherein the reference signals may be transmitted during transmission of a first and fifth OFDM symbol of each slot when a short CP is used, wherein the reference signals may be transmitted during transmission of a first and fourth OFDM symbol of each slot when a long CP is used, and wherein the reference signals are transmitted every sixth subcarrier. The communication system may comprise a LTE communication system.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a schematic diagram illustrating HARQ parallel processes and the processing time constraint;

FIG. 2 is a block diagram illustrating a receiver data flow according to an embodiment herein;

FIG. 3 is a schematic diagram illustrating reference signals according to an embodiment herein;

FIG. 4 is a block diagram illustrating a receiver according to an embodiment herein;

FIG. 5 is a block diagram illustrating a computer system according to an embodiment herein; and

FIG. 6 is a flow diagram illustrating a method according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

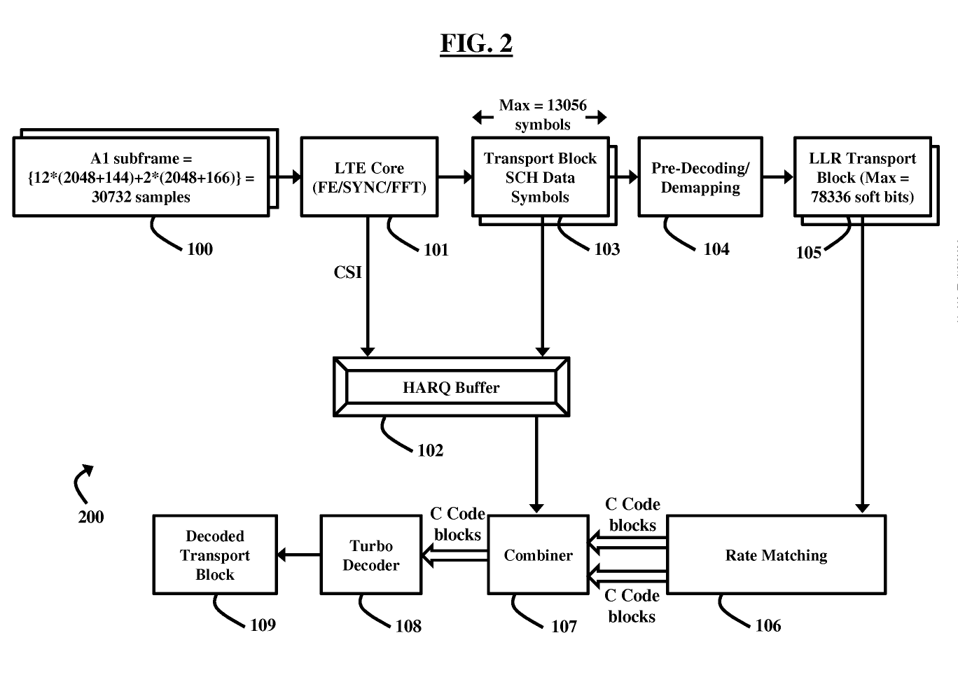

The embodiments herein provide a technique to reduce the HARQ buffer size in a wireless system for downlink shared channels. Referring now to the drawings, and more particularly to FIGS. 2 through 6, where similar reference characters denote corresponding features consistently throughout the figures, there are shown preferred embodiments.

The HARQ process needs memory because it requires storing the old transport block to combine it with the retransmitted one, this memory can be reduced by storing the transport block as Quadrature amplitude modulation (QAM) symbols (In-phase and Quadrature components) instead of soft bits, the Channel State Information (CSI) can be stored as per subcarrier, according to a first embodiment, or the pilots can be stored and the CSI will be recalculated, according to a second embodiment. Accordingly, the techniques to reduce the required member according to the embodiments herein are as follows.

According to a first embodiment, and as shown in the receiver 200 of FIG. 2, the HARQ buffer 102 is placed before the demapper 104, and each transport block 103, 105 is stored as QAM symbols in the HARQ buffer 102. In this case each retransmitted data packet is entirely stored in the HARQ buffer 102 (as it is not combined on the QAM symbols level). For each retransmission, the stored QAM symbols are re-demapped, combined (e.g., in a combiner 107) on the LLR level with all the previous retransmissions, and applied to the turbo decoder 108 for decoding and generating a decoded transport block 109. The in-phase (I) and the quadrature (Q) components as well as the CSI are all stored. The number of bits per one soft bit (LLR), Nllr=8

Now, assuming the bit widths for (I)=5 bits, (Q)=5 bits, and the CSI bit width=6 bits and category #4 UE is used, then the required HARQ buffer memory=13056 (maximum number of data symbols in transport block)*3(number of retransmissions)*2 (spatial multiplexing layers)*(5+5+6)(bit widths of I, Q, and CSI)*8(maximum HARQ parallel processes)=10.027008 MB.

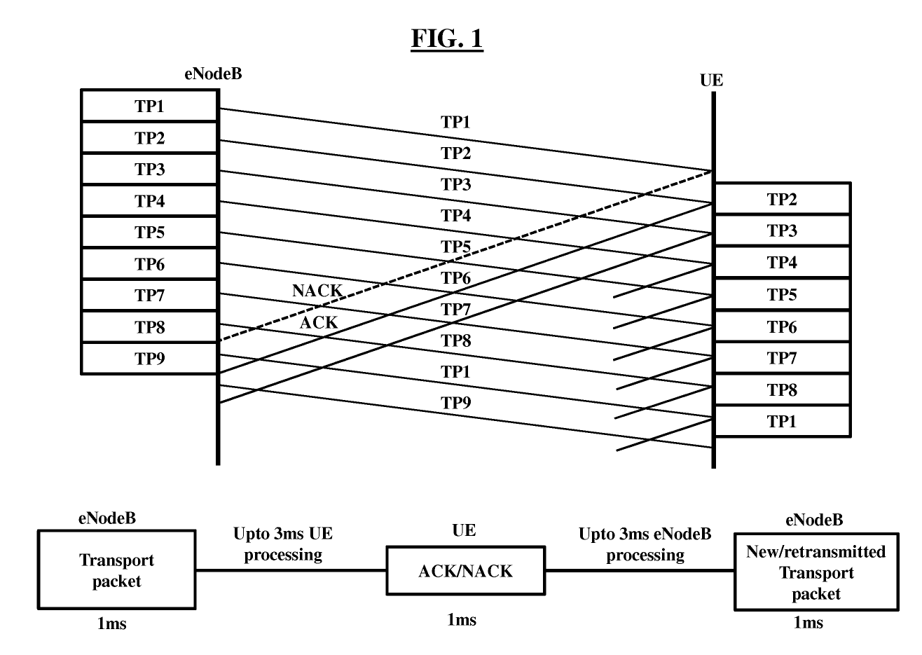

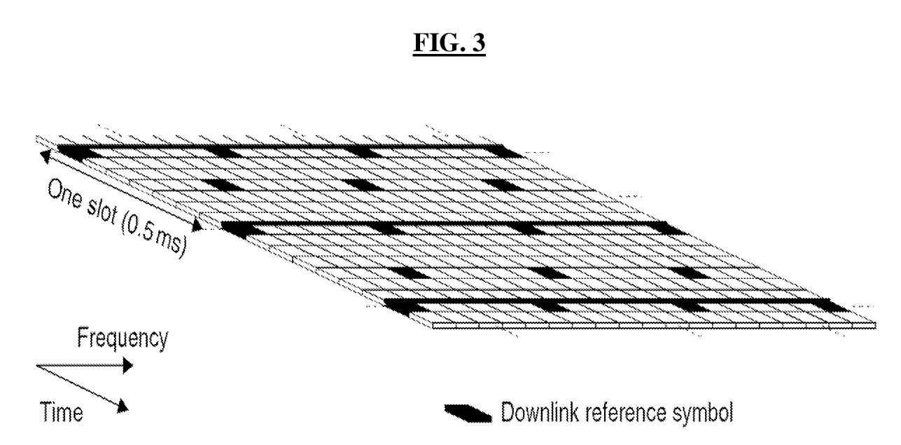

According to a second embodiment, with reference to the reference signals of FIG. 3 (with reference to FIGS. 1 through 2), the HARQ buffer (not shown in FIG. 3) is placed before channel estimation and demappers, storing only reference signals instead of the CSI. Reference signals are transmitted during the first and fifth orthogonal frequency-division multiplexing (OFDM) symbols of each slot when the short cyclic prefix (CP) is used, and during the first and fourth OFDM symbols when the long CP is used, and are transmitted every sixth subcarrier so the total number of pilots in one subframe=200*4=800.

The required HARQ buffer memory=13056(maximum number of data symbols in transport block)*3(number of retransmissions)*2(spatial multiplexing layers)*(5+5)(bit widths of I and Q)*8(maximum HARQ parallel processes)+800(number of reference signals in one subframe)*6(bit width of reference signal)*2(spatial multiplexing layers)*8(maximum HARQ parallel processes)=6.343680 MB.

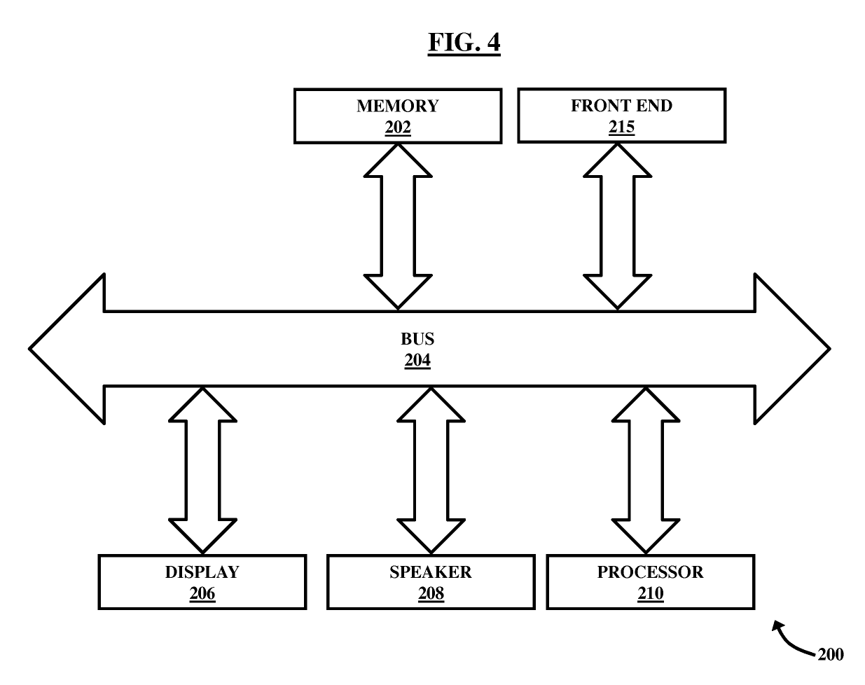

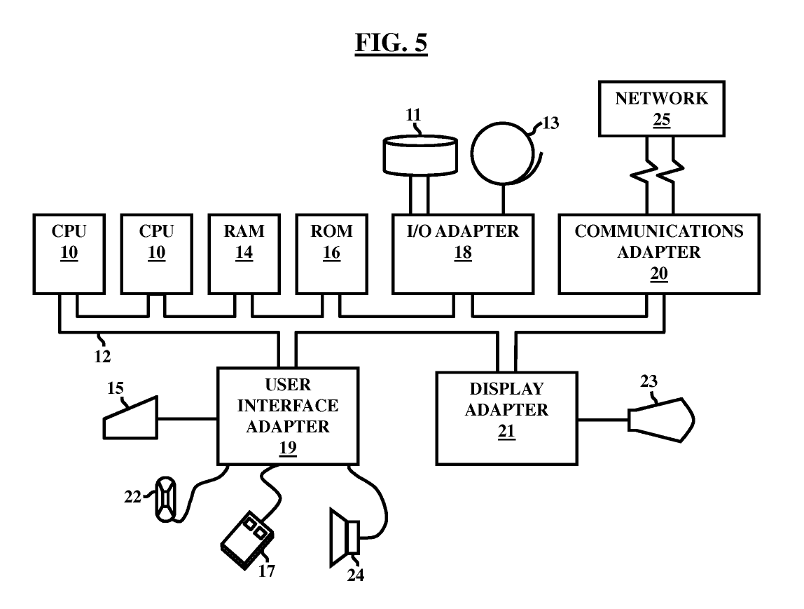

FIG. 4, with reference to FIGS. 1 through 3, illustrates an exploded view of a receiver 200 having a memory 202 comprising a computer set of instructions. The receiver 200 further includes a bus 204, a display 206, a speaker 208, and a processor 210 capable of processing a set of instructions to perform any one or more of the methodologies herein, according to an embodiment herein. The processor 210 may also enable analog content to be consumed in the form of output via one or more displays 206 or audio for output via speaker and/or earphones 208. The processor 210 may also carry out the methods described herein and in accordance with the embodiments herein. The content may also be stored in the memory 202 for future processing or consumption. A user of the receiver 200 may view this stored information on display 206. When the content is selected, the processor 210 may pass information. The content may be passed among functions within the receiver 200 using bus 204. The receiver 200 may be operatively connected to a front end 215 for communication within a wireless communication network 25 (of FIG. 5).

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 5, with reference to FIGS. 1 through 4. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

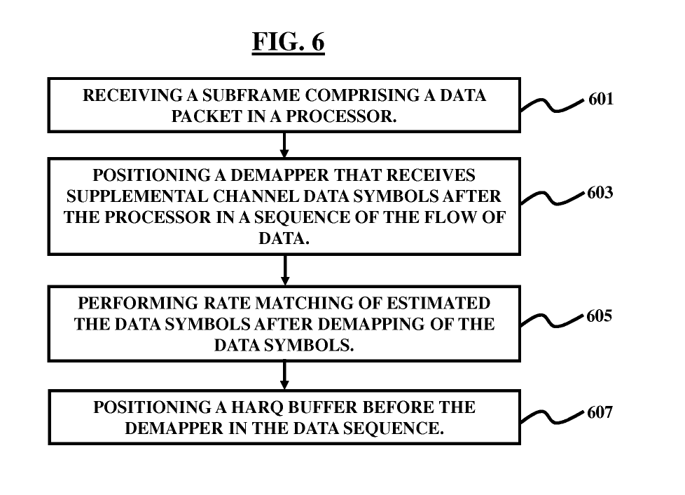

FIG. 6, with reference to FIGS. 1 through 5, illustrates a flow diagram of a method for processing a flow of data in a receiver 200 in a communication system for downlink shared channels according to an embodiment herein. The communication system may comprise a LTE communication system. The method comprises receiving (601) a subframe 100 comprising a data packet in a processor 101; positioning (603) a demapper (e.g., performing demapping 104) that receives supplemental channel data symbols (e.g., from transport block 103) after the processor 101 in a sequence of the flow of data; performing (605) rate matching 106 (e.g., using a circular buffer, for example) of estimated the data symbols after demapping (e.g., in demapper 104) of the data symbols; and positioning (607) a HARQ buffer 102 before the demapper 104 in the data sequence. The supplemental channel data symbols may be arranged in a transport block 103 that is stored as QAM symbols in the HARQ buffer 102. The data packet may be retransmitted in the data sequence, wherein the data packet may be entirely stored in the HARQ buffer 102.

The method may further comprise combining (e.g., in combiner 107) code blocks after the rate matching 106 is performed; and decoding (e.g., in turbo decoder 108) the code blocks after the combining (e.g., in combiner 107) occurs. The stored QAM symbols may be re-demapped, combined on a LLR level with all previous retransmissions of the data packet, and applied to a turbo decoder 108 that performs the decoding. The method may further comprise transmitting CSI to the HARQ buffer 102. The QAM symbols may comprise in-phase (I) and quadrature (Q) components. The method may further comprise storing only reference signals in the HARQ buffer 102. The reference signals may be transmitted during transmission of OFDM symbols, wherein the reference signals may be transmitted during transmission of a first and fifth OFDM symbol of each slot when a short CP is used, wherein the reference signals may be transmitted during transmission of a first and fourth OFDM symbol of each slot when a long CP is used, and wherein the reference signals are transmitted every sixth subcarrier.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A receiver arranged to process a flow of data in a communication system for downlink shared channels, said receiver comprising:
a processor that receives a subframe comprising a data packet;
a demapper that receives supplemental channel data symbols and is positioned after said processor in a sequence of said flow of data;
means for performing rate matching of estimated said data symbols and positioned after said demapper in the data sequence; and
a Hybrid Automatic Retransmission Request (HARQ) buffer positioned before said demapper in said data sequence.

2. The receiver of claim 1, wherein said supplemental channel data symbols are arranged in a transport block that is stored as Quadrature amplitude modulation (QAM) symbols in said HARQ buffer.

3. The receiver of claim 2, wherein said data packet is retransmitted in said data sequence, and wherein said data packet is entirely stored in said HARQ buffer.

4. The receiver of claim 3, further comprising:
a combiner positioned after said means for performing rate matching in said data sequence; and
a turbo decoder positioned after said combiner in said data sequence.

5. The receiver of claim 4, wherein the stored QAM symbols are re-demapped, combined on a log-likelihood ratio (LLR) level with all previous retransmissions of said data packet, and applied to said turbo decoder.

6. The receiver of claim 1, wherein said processor transmits channel state information (CSI) to said HARQ buffer.

7. The receiver of claim 2, wherein said QAM symbols comprise in-phase and quadrature components.

8. The receiver of claim 1, wherein said HARQ buffer stores only reference signals.

9. The receiver of claim 8, wherein said reference signals are transmitted during transmission of orthogonal frequency-division multiplexing (OFDM) symbols, wherein said reference signals are transmitted during transmission of a first and fifth OFDM symbol of each slot when a short cyclic prefix (CP) is used, wherein said reference signals are transmitted during transmission of a first and fourth OFDM symbol of each slot when a long cyclic prefix (CP) is used, and wherein said reference signals are transmitted every sixth subcarrier.

10. The receiver of claim 1, wherein said communication system comprises a long-term evolution (LTE) communication system.

11. A method for processing a flow of data in a receiver in a communication system for downlink shared channels, said method comprising:
receiving a subframe comprising a data packet in a processor;
positioning a demapper that receives supplemental channel data symbols after said processor in a sequence of said flow of data;
performing rate matching of estimated said data symbols after demapping of said data symbols; and
positioning a Hybrid Automatic Retransmission Request (HARQ) buffer before said demapper in the data sequence.

12. The method of claim 11, wherein said supplemental channel data symbols are arranged in a transport block that is stored as Quadrature amplitude modulation (QAM) symbols in said HARQ buffer.

13. The method of claim 12, wherein said data packet is retransmitted in said data sequence, and wherein said data packet is entirely stored in said HARQ buffer.

14. The method of claim 13, further comprising:
combining code blocks after said rate matching is performed; and
decoding said code blocks after the combining occurs.

15. The method of claim 14, wherein the stored QAM symbols are re-demapped, combined on a log-likelihood ratio (LLR) level with all previous retransmissions of said data packet, and applied to a turbo decoder that performs said decoding.

16. The method of claim 11, further comprising transmitting channel state information (CSI) to said HARQ buffer.

17. The method of claim 12, wherein said QAM symbols comprise in-phase and quadrature components.

18. The method of claim 11, further comprising storing only reference signals in said HARQ buffer.

19. The method of claim 18, wherein said reference signals are transmitted during transmission of orthogonal frequency-division multiplexing (OFDM) symbols, wherein said reference signals are transmitted during transmission of a first and fifth OFDM symbol of each slot when a short cyclic prefix (CP) is used, wherein said reference signals are transmitted during transmission of a first and fourth OFDM symbol of each slot when a long cyclic prefix (CP) is used, and wherein said reference signals are transmitted every sixth subcarrier.

20. The method of claim 11, wherein said communication system comprises a long-term evolution (LTE) communication system.
